(19) United States
(12) Patent Application Publication
(10) Pub. No.: US 2021/0270530 A1
(43) Pub. Date: Sep. 2, 2021

(54) Body of a process furnace

(71) Applicant: Intekhenergo, Volzhsky (RU)

(72) Inventor: Alexander V. Shevtsov, Volzhsky (RU)

(21) Appl. No.: 17/321,446

(22) Filed: May 15, 2021

Related U.S. Application Data
(63) Continuation-in-part of application No. 16/302,641, filed on Nov. 17, 2018.

(51) Int. Cl. F27D 1/00; C09D 7/61; C09D 7/40

(52) U.S. Cl. CPC F27D 1/0033; C09D 7/70; C09D 7/61

(57) ABSTRACT

A body of a process furnace for reforming, steam boilers and heating up starting materials is made of steel and comprises an internal lining inside the body and an outer coating outside the body. The outer coating is discrete, structurally heterogeneous and presents a mixture of water (from 60 to 30 vol. %) and polymers with fillers (from 40 to 70 vol. %). Used as the fillers are expanded perlite or microspheres. The thickness of the outer coating is from 0.4 to 2.0 mm. Technical results of the structure is lowering heat loss from the body.

### CROSS-REFERENCE TO RELATED APPLICATIONS

The present application is a CIP of U.S. application Ser. No. 16/302,641 filed Nov. 17, 2018, which is a CIP National phase application of PCT/RU2017/050039 filed May 15, 2017, which claims priority to Russian application 2016119411 filed May 19, 2016, all three applications being incorporated herein by reference in their entirety.

### BACKGROUND OF THE INVENTION

### 1. Field of the Invention

The present technical design relates to a body structure of a process furnace, can be used as an enclosure structure of a process furnace for reforming, steam boilers, furnaces for heating up starting materials and aims at decreasing fuel consumption due to lowering heat transfer from the process furnace body into environment.

Known process furnace designs contribute to some extent to lowering heat transfer from the process furnace body to the environment, mainly due to using internal lining. However, as it follows from the below description of prior art, the problem of lowering fuel consumption for compensating heat loss from the body has not been solved. Increasing thickness of the furnace lining results in either decreasing the internal space of the furnace leading to the output reduction or in the increase of outer dimensions of the furnace resulting in the increase of the cost of the process furnace.

### 2. State of the Art

Known in the art are tubular heating furnaces according to P [symbol] 3688-00220302-003-04 (Regulatory document for operational requirements to tubular heating furnaces, 2004). A tubular furnace comprises equipment (product coils, coils for producing and/or overheating steam vapor, air heaters), suspenders, racks and supports for coils; burner arrangements (using gas fuel, residual fuel oil or composite fuel); fittings (access hatches, explosion relief flanges, gates); heat barriers (lining, thermal); support and enclosure metal structures; stairs, interstair paces, gas pipes, air ducts, piping systems, chimney shafts; draught systems (fans and kiln fans).

When estimating the thickness of the lining and thermal of the furnace body, gas pipes, air ducts, and piping systems, it is assumed that the design temperature on the outer surface of the above elements is secured to be such as to meet the accepted value of the technical and economic indexes of the furnace and safety requirements.

The estimation of heat loss through the furnace casing is to take into account the air temperature equal to the average yearly air temperature at the location of the furnace and surface heat-transfer coefficient of 35 kc/m²h° C.

The outside surface temperature of any surface element at the servicing zone must not exceed 60° C. Outside the limits of the operational and servicing zones of the furnace, the surface temperature of any element can rise to 80° C. at the average maximum temperature of the hottest month at the location of the furnace.

The disadvantage of this design lies in large heat loss from the furnace body. Specifically, even at the minimum permissible temperature of the process furnace of 60° C. a “standardized” fuel consumption to compensate for the heat loss from the body exceeds 5% of the total consumption.

Known has been Russian utility model patent 130664 “Multilayer heat isolation”. The multilayer heat isolation comprises a prime coat including a water-ceramic composition of the “Hot Pipe Coating” brand, at least one first heat-insulating layer including a water-ceramic composition of the “Hot Pipe Coating” brand placed onto the prime coat, and following heat-insulating layers including water-latex ceramic composition of the “Temp-Coat” brand placed on each other by their respective surfaces and placed by the surface of the second layer thereof on the surface of at least the one first heat-insulating layer.

This design suffers from heaviness of the isolation structure, inability of the constant monitoring of the process furnace surface under the multilayer coating, as well as from the isolation repair complexity and short life of this type of coating.

A plurality of relevant patents has been known in the art:

RU 2304600C2, C09B 5/02, of Aug. 20, 2007. The design of an anti-corrosive and heat-insulating coating for pipelines uses a composition filled with hollow microspheres. The invention relates to chemical industry and means used for anti-corrosive and overheat protection of various surfaces, specifically metallic, concrete and plastered surfaces, as well as other engineering structures of metal and concrete operating in hostile environment, especially for the thermal isolation and corrosive protection of pipelines, including the thermal isolation of heat and water supply pipelines.

RU 2502763C1, C09b 5/02, of Dec. 27, 2013 related to anti-corrosive and thermal isolation coating made of a water-turbid composition with viscosity from 1 up to 100 Pa·s and including a mixture of a polymer binder (5-95 vol. %) and hollow microspheres as a filler (5-95 vol. %).

RU 2311397C2, C04B 41/48, of Nov. 27, 2007. A composition for thermal isolation coating comprising hollow ceramic microspheres as a filler, a polymer binder, a processive additive and water is characterized in that it comprises hollow microspheres as the filler and comprises latex as the polymer binder.

All the above patents relate to the structure and composition of liquid-ceramic materials proposed by the inventors for thermal isolation of, for example, a process furnace.

A process furnace (PF) is sometimes confused with a crucible furnace (CF), the latter being erroneously considered an embodiment of a process furnace. Such misconception, as well as being erroneous in essence, may also result in depreciation of inventive contribution and therefore has to be avoided. A PF and a CF belong to two widely different types of furnaces. Indeed, a PF is an apparatus intended for heating—by heat resulting from fuel burning in a PF combustion chamber—liquid products, such as petrochemicals, or starting materials which continuously flow through the furnace. When working with an oil refinery, the PF comprises separated radiant and convection chambers through which heated petrochemicals continuously run. An industrial CF, on the other hand, is a melting or calcining unit which is commonly used in foundry and deals with metals, such as metal charge, ore, and friable products charged into CF and staying therein. While PF are large installations of up to 100 ft in height, the size of CF, whose capacity (in respect to steel, for example) reaches up to 30 ton, is no more than 4 cubic meters in volume (as in a cube with an edge of about 5 feet). PF are standing apart outdoor installations. On the other hand, a CF cannot be placed outdoors—when metal inside the CF is melted and has to be tapped from the CF, it cannot be done outdoors, so CF are placed indoor.

With regard to applying outer thermal protection to PF and CF, a lining (refractory backing) in a PF protects the body of PF, as needed, from overheating, and adding an outer heat-protection coating presents problems discussed below. In a CF such outer thermo-protective coating is meaningless since a CF, unlike a PF, does not have a hermetically closed body and its lid allow gases to escape therefrom.

A process furnace comprises a metallic (rarely brick or concrete) body and internal lining. However, using liquid-ceramic and other thermal isolation materials for heat isolation of the process furnace outside the body results in a number of disadvantages.

Particularly, where rockwool or foamed polyurethane coating are used for the outside protection, visual control of the furnace body surface condition is impossible. Industry-specific regulations for maintaining fire potential equipment require having constant visual heat-monitoring of the condition of the body surface of process furnaces. Additionally, load upon the body increases, and the temperature of the body under the isolation rises.

Where liquid-ceramic materials are used for the process furnace outside-the-body isolation, the body temperature increases. Heat conductivity factor of 0.003 to 0.001 W/m ° C. disclosed in the specifications of liquid-ceramic materials provides thermal resistance of a layer of 3.0 mm to be no less than 1.0 m²° C. This increase of the thermal resistance of the last layer results in the increase of the process furnace body temperature by more than 100° C. Proportionally increasing is the temperature of the internal lining. Overheating the lining and the body cover decreases operational lifetime of the process furnace.

Also, those liquid materials fail to meet the requirements of fire safety regulations for explosion-hazardous production facilities.

### BRIEF SUMMARY OF THE INVENTION

The goal the proposed invention purports to solve lies in modifying the structure of the process furnace body outside surface in such a way as to lower the heat transfer from the surface into the environment due to decreasing heat radiation and convective heat transfer.

The technical result of the proposed invention resides in decreasing heat loss from the process furnace body.

The above technical result is achieved in the proposed enclosure structure for a body of a process furnace, which comprises a body with a frame and an internal lining, by means of providing the body on an outside surface thereof with a discrete coating, heterogeneous by the structure thereof, the coating comprising water and a mixture of acrylic polymers and dispersed fillers, the mixture containing 40-70 vol. % and water containing 60-30 vol. % of the total volume.

Specifically, the filler can include expanded perlite. Understood by perlite in the present specification is an amorphous volcanic glass that has a relatively high water content, typically formed by the hydration of obsidian. It occurs naturally and has the unusual property of greatly expanding when heated sufficiently. It is an industrial mineral and a commercial product useful for its low density after processing (https://en.wikipedia.org.wiki/Perlite). In a particular case, the term microsphere is applied to a finished product.

Also, the filler can include microspheres.

Additionally, thickness of the coating is between 0.4 to 2 mm.

A composition is applied from the outside of the process furnace enclosure, the composition comprising the filler (for example, microspheres, expanded perlite, etc.).

Compositions of a mixture of acrylic polymers (28% wt), water (47% wt) and fillers —oxides of calcium, silicon and titanium (total 25% wt) dispersed in the composition may serve as an example thereof. Or compositions of a mixture of latexes (65-75% wt) and expanded perlites (calcium and titanium oxides, 35-25% wt) dispersed therein. Or, for example, compositions of a mixture of latexes (65-75% wt) and microspheres (silicon oxides, 35-25% wt) dispersed therein.

Formed upon solidification of the composition is a layer of an entire coating having lower heat transfer and heat conductivity coefficients, as compared to those of the body and frame materials.

Compositions of water and a mixture of acrylic polymers and fillers dispersed therein (and containing from 40 up to 70% of the volume of the whole composition), a mixture of latexes and expanded perlites dispersed therein (and containing from 40 up to 70% of the volume of the whole composition), or, for example, a mixture of latexes and microspheres dispersed therein (and containing from 40 up to 70% of the volume of the whole composition) may serve as examples of such compositions.

The resulting layer of a coating formed on the body surface has lower heat transfer and heat conductivity coefficients in contrast with those of the body and frame materials.

With the maximum permissible thickness of the coating of 0.2 mm in view, it is only due to the presence of the filler in the coating that allows for lowering heat transfer from the surface of the material. By properties, the resulting surface is discrete rather than entire (solid). As compared with a solid structure of a material, a discrete one has lower heat transfer and heat conductivity. At the same time, the mentioned thickness of the coating prevents the process furnace body metal from overheating and does not get in the way of controlling the body condition visually. A number of fire safety requirements with regard to the structure are met herewith as well.

### BRIEF DESCRIPTION OF DRAWINGS

Details, features and advantages of the present invention will be explained in the ensuing description of the embodiments thereof and accompanying drawings, in which:

FIG. 1 illustrates an example of an enclosure structure of the body of the process furnace for heating up starting materials;

FIG. 2 shows an example of an enclosure structure of the body of the process furnace for primary crude oil processing;

FIG. 3 depicts an example of an enclosure structure of the body of the process furnace for heating up starting materials with an additional protective coating; and

FIG. 4 reflects an example of an enclosure structure of the body of the process furnace for primary crude oil processing with an additional protective coating.

Denoted in the drawings are the following positions: 1—a body of the furnace; 2—an outside frame; 3—an integrated structure of the internal lining and thermal; 4—an outer coating of the body and frame of the furnace with a discrete composition, heterogeneous by the structure thereof, the composition having thickness of no more than 2.0 mm and comprising, for example, water and a mixture of acrylic polymers and fillers dispersed therein and comprising 40-70% of the volume of the whole composition.

### DETAILED DESCRIPTION

The technical solution relates to the body of process furnaces and can be used at the metallurgic, chemical and petroleum refining facilities for energy usage reduction and enhancement of the personnel's safety, as well as for additional protection of the process furnace metallic frame from unfavorable environment factors. Designs of the process furnace known in the art conduce, to a degree, and mainly due to the use of internal lining, the lowering of heat transfer from the body of process furnace. However, as it follows from the analysis of the prior art, the problem of decreasing the fuel consumption to compensate for the heat loss from the body has not yet been solved. Increasing the thickness of the furnace lining results in either decreasing the internal space of the furnace leading to the reduction of the output thereof, or in the increase of outer dimensions of the furnace resulting in the increase of the cost of the process furnace.

In the proposed invention, a discrete composition, heterogeneous by the structure thereof and no more than 2.0 mm in thickness, is applied to an outside surface of the enclosure structure (the process furnace body), the composition lowering radiation heat loss while being transparent for heat monitoring of the body. This composition though applied to the outside surface of the process furnace body is not a thermoprotective coating and does not perform functions thereof.

Cited as examples of such discrete compositions can be compounds comprising water and a mixture of acrylic polymers and fillers dispersed therein and making from 40 to 70% of the whole composition, or a mixture of latexes and expanded perlites dispersed therein (from 40 to 70% of the whole composition), or a mixture of latexes and microspheres dispersed therein (from 40 to 70% of the whole composition).

Developed at the surface of the body after the polymerization of the compound is a layer of a discrete, heterogeneous coating possessing, as compared with the materials of the process furnace body and frame, lower heat transfer and heat conductivity.

The minimal thickness of the coating is limited by the spreading capacity of the composition of the coating. For example, for compositions using microspheres as a filler, the spreading capacity is no less than 0.2 mm, whereas it is no less than 0.4 mm for those using expanded perlite as a filler. Maximal thickness of the coating, namely 2.0 mm, is limited by fire safety regulations for particularly hazardous facilities.

Where the mixture is less than 40% of the whole composition, discrete properties of the coating surface sharply deteriorate. In case it is more than 70%, linear stretching of the finished coating decreases, thus lowering service time of the coating.

It is only where the quantity of the polymers and fillers is between 40 and 70% that the heat transfer from the surface of the material decreases. Formed is a discrete surface rather than the entire one. The discrete structure of the material has lower heat transfer and conductivity as compared with the entire one. At the same time, the above-identified thickness of the coating prevents the process furnace body metal from overheating and does not get in the way of controlling the condition of the body visually. Also, fire safety requirements with regard to the process furnace structure are met herewith as well.

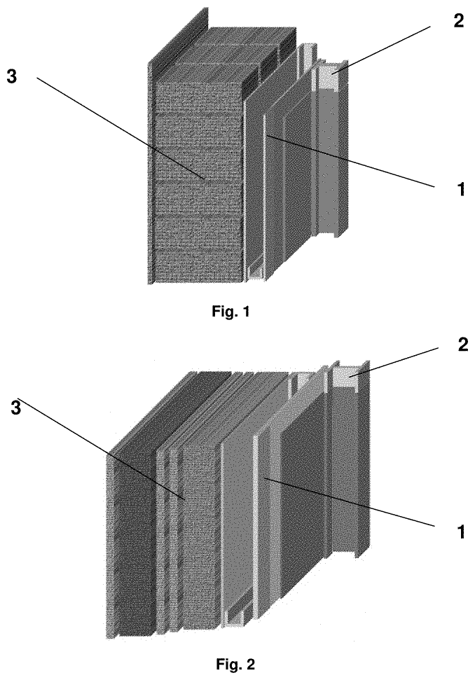

FIG. 1 exemplifies the process furnace structure for heating up starting materials.

The enclosure structure of this process furnace comprises a layer of internal lining of fire-brick protected from inside by a thermostable filler. There is also an integrated structure of a steel casing of the body and frame. The steel casing of the body and frame is covered with an antirust compound and a protective enamel. Brands and technical characteristics of the materials used for the process furnace, which depend on the process furnace operation condition requirements, vendor capacity, and the cost of the materials used, have no impact on the proposed design.

FIG. 2 shows an example of the process furnace structure used for primary crude oil processing.

The enclosure structure of this process furnace comprises a layer of internal lining of mineral wool mats protected from inside by a thermostable filler and layers of thermal from mineral wool boards. There is also an integrated structure of a steel casing of the body and frame. The steel casing of the body and frame is covered with an antirust compound and a protective enamel. Brands and technical characteristics of the materials used for the process furnace, which depend on the process furnace operation condition requirements, vendor capacity, and the cost of the materials used, have no impact on the proposed design.

In both above examples, the end element is the steel casing. It is known that steel has high value of heat transfer, and protection paint does not decrease the value of heat transfer.

Heat transfer coefficient is a value characterizing the rate of heat dissipation, and it is defined by the ratio of the current of heat released by a surface to the temperature difference between this surface and adjacent environment. A design heat transfer coefficient, according to the Building code (CNR (Construction Norms and Rules) 2.04.14-88, as applied, appendix 9) is equal to 35 W/m²° C.

An open metallic (or brick or concrete) surface possesses high value of the heat transfer coefficient which is due to physical properties of the materials used for the process furnace body. The object of the proposed design is to change physical structure of the outer heat dissipating surface that would result in decreasing heat transfer therefrom. In doing so, the possibility of visual monitoring of the process furnace body surface condition should be kept, and the overheating of the body should be avoided.

Generally, the enclosure structure comprises three basic elements—a body, a frame securing the integrity of the body, and an internal lining (potentially with thermal elements). In some cases, a strengthened design of the lining, such as in open-hearth furnaces, serves as the body and frame as well.

Unlike the traditional body structure comprising the internal lining (thermal) and body with frame, the proposed process furnace enclosure structure comprises four elements: a body 1, a frame 2, an aggregate 3 of internal lining and thermal, and an outer protective coating 4, no more than 2.0 mm in thickness, formed by a discrete composition, heterogeneous by structure thereof, such as water and a mixture of acrylic polymers and fillers dispersed in water and containing from 40 to 70% of the total volume of the composition.

Examples of these compositions are water and a mixture of acrylic polymers and fillers dispersed therein and containing from 40 to 70% of the total volume of the composition; or water and a mixture of latexes and expanded perlite (the mixture containing from 40 to 70% of the total volume of the composition) dispersed therein; or water and a mixture of latexes and microspheres (from 40 to 70% of the total volume of the composition) dispersed therein.

Due to lower, as compared with that of the material of the process furnace body, heat transfer and heat conductivity of the additional coating of the enclosure structure of the process furnace, heat loss from the body and frame of the process furnace into the atmosphere decreases.

Thus, the proposed design results in lowering fuel consumption to compensate for the heat loss from the process furnace body into surrounding air.

The maximal thickness of the protective coating, equal to 2 mm, is limited by the necessity to assure visual monitoring of the condition of the process furnace surface.

The limiting of the volume of the polymers and filler used in the protective coating to 40-70% of the total volume results from the finding that if their volume is less than 40%, the decrease of the heat transfer from surface is insufficient and does not outweigh the prior expenses, whereas where the volume of the mixture of polymers and filler is more than 70% of the total volume, the capacity of the protective coating to linear stretching decreases, resulting in the destruction of such coating after the furnace shutdown.

A mixture of butadiene-styrene latex, acrylic polymers, ammonia, and water with a mixture of such fillers as expanded perlite, quartz, zinc oxide and titanium dioxide can serve an example of the composition of the protective coating according to the proposed design.

Weight percentage of a solvent (water) is 47%, weight percentage of nonvolatile substances is 53%, the latter comprising 28% of polymeric components and 25% of noncombustible inorganic components, the nonvolatile inorganic components comprising 25% of silicon oxide, 28% of titanium oxide, 19% of calcium oxide, 20% of zinc oxide, 5% of potassium oxide, and 3% of ferrous oxide.

It was established as a result of the research of the characteristics of the protective coating of the above-identified composition that the density of the coating is 410 kg/m³; specific heat capacity is 1.120 kJ/kg ° C.; the coefficient of heat transfer is 2.0-3.0 W/m²° C.; coating combustibility—CC1.

For comparison, the coefficient of heat transfer from a metallic surface to surrounding air, according to the Building code (CNR 2.04.14-88, as applied, appendix 9) is equal to 35 W/m²·° C.

Compared below are two variants of calculation of heat loss from the process furnace body—without the protective coating and with the same.

Variant 1 with no protective coating (FIG. 1).

Heat transfer resistance where

$$R = \frac{1}{α 1} + \frac{δ}{λ} + \frac{1}{α 2} ,$$

α1—heat absorption coefficient—50 W/m²° C.
δ—thickness of the enclosure structure—0.2 m
λ—average heat conductivity coefficient for the whole enclosure structure—1.0 W/m²° C.
α2—coefficient of heat transfer from the surface—35 W/m²° C.
R—design resistance to heat transfer—0.25 m²° C./W.

Heat loss from the structure under consideration where

$$- q = \frac{t - t 3}{R} ,$$

t—ambient temperature inside the furnace—800° C.
t3—temperature of surrounding air—0° C.
q—design heat loss—3144 W/m².

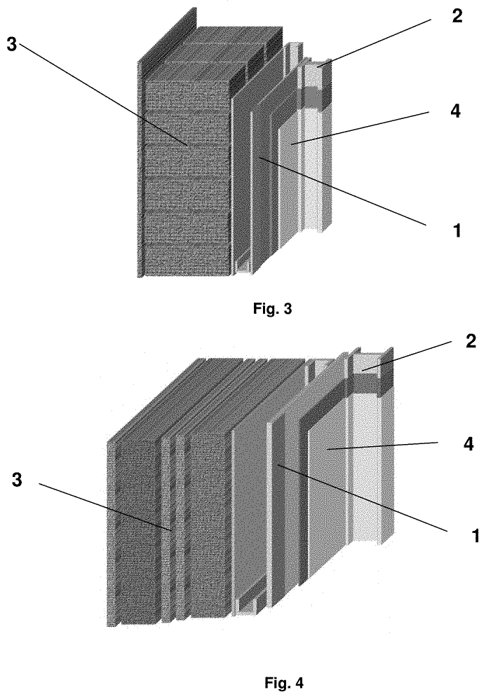

Variant 2 with protective coating (FIG. 3).

Note: to simplify the comparable estimation, the change of thickness of the enclosure structure and of the heat conductivity resulting from applying the protective coating is not taken into account.

Heat transfer resistance where

$$R = \frac{1}{α 1} + \frac{δ}{λ} + \frac{1}{α 2} ,$$

α1—heat absorption coefficient—50 W/m²° C.
δ—thickness of the enclosure structure—0.2 m
λ—average heat conductivity coefficient for the whole enclosure structure—1.0 W/m²° C.
α2—coefficient of heat transfer from the surface—3.0 W/m²° C.
R—design resistance to heat transfer—0.55 m²° C./W.

Heat loss from the structure under consideration where

$$- q = \frac{t - t 3}{R} ,$$

t—ambient temperature inside the furnace—800° C.
t3—temperature of surrounding air—0° C.
q—design heat loss—1446 W/m².

The change of heat transfer of the enclosure structure of the process furnace according to the present invention makes it possible to have heat loss from the process furnace body 2.2 times lower.

1. A body of a process furnace for reforming, steam boilers and heating up starting materials, the body being made of steel and comprising an internal lining inside the body and an outer coating outside the body, the outer coating being discrete, structurally heterogeneous and comprising a mixture of water (from 60 to 30 vol. %) and polymers with fillers (from 40 to 70 vol. %), thus lowering heat loss from the body.

2. The body per claim 1, wherein the fillers include expanded perlite.

3. The body per claim 1, wherein the fillers include microspheres.

4. The body per claim 1, wherein thickness of the outer coating is from 0.4 to 2.0 mm.
